(19) United States
(12) Patent Application Publication
(10) Pub. No.: US 2011/0147143 A1
(43) Pub. Date: Jun. 23, 2011

(54) ELECTRONIC PARKING BRAKE ACTUATOR

(75) Inventor: Inuk Park, Seoul (KR)

(73) Assignee: HYUNDAI MOBIS CO., LTD., Seoul (KR)

(21) Appl. No.: 12/970,741

(22) Filed: Dec. 16, 2010

(30) Foreign Application Priority Data
Dec. 23, 2009 (KR) 10-2009-0129978

(51) Int. Cl. B60T 13/74

(52) U.S. Cl. 188/158

(57) ABSTRACT

Provided is an electronic parking brake actuator generating power for braking by using power from a motor, transmits the power from the motor to a caliper, stably and without noise, and ensures more quiet operability and durability by preventing and blocking noise and vibration generated by the actuator.

### CROSS-REFERENCE TO RELATED APPLICATIONS

The present application claims priority to Korean Patent Application Number 10-2009-0129978 filed Dec. 23, 2009, the entire contents of which application is incorporated herein for all purposes by this reference.

### BACKGROUND

1. Field

The present disclosure relates to an electric parking brake actuator

2. Discussion of the Related Technology

Electronic parking brakes generate braking force for keeping a vehicle parked by using power generated by an actuator, instead of operation force for braking from a driver which is transmitted through a parking cable in the related art, such that manual operation of the driver is not needed, and accordingly, they provide convenience and make it possible to implement elegant vehicles.

The information disclosed in this Background section is only for enhancement of understanding of the general background of the invention and should not be taken as an acknowledgement or any form of suggestion that this information forms the prior art already known to a person skilled in the art.

### SUMMARY

One aspect of the present invention provides an electronic parking brake actuator that generates power for braking by using power from a motor, transmits the power from the motor to a caliper, stably and without noise, and ensures more quiet operability and durability by preventing and blocking noise and vibration generated by the actuator.

An embodiment of the present invention provides an electronic parking brake actuator including: an actuator case and an actuator cover which define a closed space by being combined with each other; a motor coupled to the actuator case; a gear set including a plurality of gears to change speed of rotational force and torque which are provided from the motor, and disposed between the actuator cover and the actuator case; and a gear box covering the gear set inside the actuator cover and the actuator case.

According to an electronic parking brake actuator generating power for braking by using power from a motor, it is possible to transmit the power from the motor to a calliper, stably and without noise, and ensure more quiet operability and durability by preventing and blocking noise and vibration generated by the actuator.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a view showing an example of an electronic parking brake actuator.

FIG. 2 is a view showing an electronic parking brake actuator according to an embodiment of the present invention.

It should be understood that the appended drawings are not necessarily to scale, presenting a somewhat simplified representation of various features illustrative of the basic principles of the invention. The specific design features of embodiments of the present invention as disclosed herein, including, for example, specific dimensions, orientations, locations, and shapes will be determined in part by the particular intended application and use environment.

In the figures, reference numbers refer to the same or equivalent parts of embodiments of the present invention throughout several figures of the drawing.

### DETAILED DESCRIPTION OF EMBODIMENTS

Reference will now be made in detail to various embodiments of the present invention(s), examples of which are illustrated in the accompanying drawings and described below. While the invention(s) will be described in conjunction with embodiments, it will be understood that the present description is not intended to limit the invention(s) to those embodiments. On the contrary, the invention(s) is/are intended to cover not only the embodiments, but also various alternatives, modifications, equivalents and other embodiments, which may be included within the spirit and scope of the invention as defined by the appended claims.

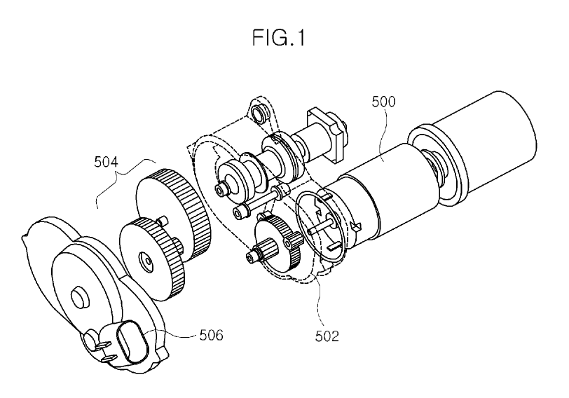

FIG. 1 is a view showing an example of an electronic parking brake actuator, in which a motor 500 generating power for producing braking force is coupled to an actuator case 502. A gear set 504 includes a plurality of gears to transmit the power generated from motor 500 to a caliper, with torque increased at a predetermined reduction gear ratio.

However, the gears of gear set 504 are disposed with the rotary shafts fixed to actuator case 502 and an actuator cover 506, as shown in FIG. 1, such that the dimensional accuracy for relative positions between the rotary shafts of the gears is a little low, which causes noise and vibration when the actuator operates, and decreases durability, and the vibration is completely transmitted to the calliper and the car body.

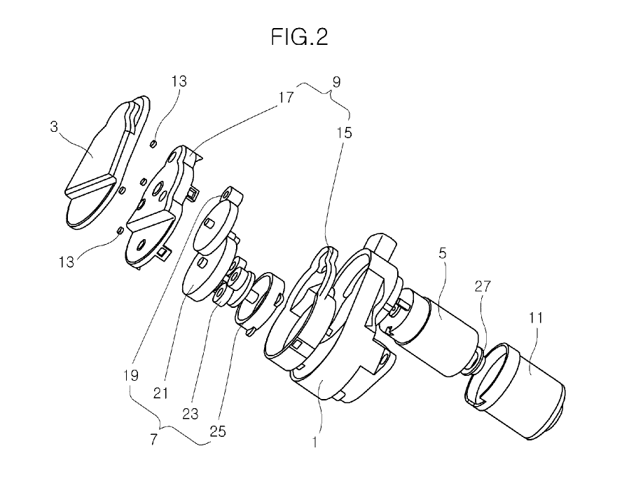

Referring to FIG. 2, an electronic parking brake actuator according to an embodiment of the present invention includes an actuator case 1 and an actuator cover 3 which define a closed space by being combined with each other. The actuator further includes a motor 5 coupled to actuator case 1; a gear set 7 including a plurality of gears to change speed of rotational force and torque which are provided from motor 5, and disposed between actuator cover 3 and actuator case 1; and a gear box 9 covering gear set 7 inside actuator cover 3 and actuator case 1.

In some embodiments, motor 5 is disposed at a side of actuator case 1, while gear box 9 housing gear set 7 is disposed at the other side. The space where gear box 9 is disposed is covered and sealed by actuator cover 3. Gear box 9 has a function of supporting the rotary shafts of the gears of gear set 7 and houses all the gears such that gear box 9 and gears form a single module. In this configuration, the gears are more accurately assembled and easily handled.

The motor is covered by a motor cover 11 at a side of actuator case 1 while gear box 9 housing gear set 7 is inserted at the other side of actuator case 1 and sealed by actuator cover 3.

In particular, a plurality of vibration-proof rubbers 13 (which can also be referred to as vibration absorbing members) is disposed between gear box 9 and actuator case 1, and between gear box 9 and actuator cover 3 such that vibration is not transmitted therebetween.

Therefore, noise and vibration generated when gear set 7 operates. Such noise and vibration are blocked by vibration-proof rubbers 13, such that they are transmitted very little to the outside of actuator case 1 and actuator cover 3.

Gear box 9 includes a gear box case 15 and a gear box cover 17. The rotary shafts of the gears in gear box 9 are arranged in the same direction as the combination direction of gear box case 15 and gear box cover 17. In the embodiment shown in FIG. 2, for reference, the gears of gear set 7 include a motor pinion 19 coupled to the rotary shaft of motor 5, a spur gear 21, a planetary gear 23, and a ring gear 25.

In the embodiment, as shown in FIG. 2, a motor vibration-proof rubber 27 may be disposed also between motor 5 and motor cover 11.

Therefore, according to the electronic parking brake actuator having the structure described above, the noise and vibration of gear set 7 operated by the operation of motor 5 are not transmitted and blocked to the outside of actuator cover 3 and actuator case 1, and gear set 7 housed in gear box 9 can be more accurately assembled, such that more smooth, stable, and quiet operation can be achieved. Therefore, durability of the actuator can be improved.

The foregoing descriptions of specific embodiments of the present invention have been presented for purposes of illustration and description. They are not intended to be exhaustive or to limit the invention to the precise forms disclosed, and obviously many modifications and variations are possible in light of the above teachings. The embodiments were chosen and described in order to explain certain principles of the invention and their practical application, to thereby enable others skilled in the art to make and utilize various embodiments of the present invention, as well as various alternatives and modifications thereof. It is intended that the scope of the invention be defined by the Claims appended hereto and their equivalents.

What is claimed is:

1. An electric parking brake actuator comprising:
an actuator case;
an electric motor attached to the actuator case;
a gear train module configured to transfer power from the electric motor toward a caliper and located inside the actuator case, the gear train module comprising;
a plurality of gears, each of which is rotatable about an axis, and
a gear train housing fixed to the actuator case, located inside the actuator case, enclosing the plurality of gears, and supporting the plurality of gears,
a plurality of vibration absorbing members interposed between the gear train housing and the actuator case.

2. The actuator of claim 1, wherein each of the plurality of vibration absorbing members contact the gear train housing and the actuator case.

3. The actuator of claim 1, wherein the plurality of vibration absorbing members comprises a rubber material.

4. The actuator of claim 1, wherein the plurality of gears do not contact the actuator case.

5. The actuator of claim 1, wherein the actuator case comprises:
an actuator case comprising an end wall and a sidewall extending from the end wall to define a space for accommodating the gear train module, the side wall extending parallel to the axis, and
an actuator cover coupled to the sidewall.

6. The actuator of claim 5, wherein at least one of the plurality of vibration absorbing members is interposed between and contacts the gear train housing and the actuator cover.

7. The actuator of claim 5, wherein at least one of the plurality of vibration absorbing members is interposed between and contacts the gear train housing and the actuator case.

8. An electronic parking brake actuator comprising:
an actuator case and an actuator cover which define a closed space by being combined with each other;
a motor coupled to the actuator case;
a gear set comprising a plurality of gears to change speed of rotation from the motor, and disposed between the actuator cover and the actuator case; and
a gear box covering the gear set and located in the closed space.

9. The electronic parking brake actuator as defined in claim 8, wherein the motor is covered by a motor cover at a side of the actuator case, and
the gear box housing the gear set is inserted at the other side of the actuator case and sealed by the actuator cover.

10. The electronic parking brake actuator as defined in claim 9, wherein a plurality of vibration-proof rubbers is disposed between the gear box and the actuator case, and the actuator cover to insulate vibration therebetween.

11. The electronic parking brake actuator as defined in claim 10, wherein the gear box comprises a gear box case and a gear box cover, and
rotary shafts of the gears in gear box are arranged in the same direction as the combination direction of the gear box case and the gear box cover.
